(19) United States
(12) Patent Application Publication
(10) Pub. No.: US 2026/0338531 A1
(43) Pub. Date: Oct. 29, 2026

(54) PHYSICAL METROLOGY TIE-IN TOOL FOR PORTABLE DEVICES

(71) Applicant: Spirit AeroSystems, Inc., Wichita, KS (US)

(72) Inventors: Zahir Nachedi, Wichita, KS (US); Joseph Nellis, Wichita, KS (US)

(21) Appl. No.: 19/188,671

(22) Filed: Apr. 24, 2025

(51) Int. Cl. G01B 5/25

(52) U.S. Cl. CPC G01B 5/25

(57) ABSTRACT

A tie-in tool for facilitating the accurate combination of multiple group measurements of a three-dimensional part includes a first plate and a second plate connected along a connection region, position indicators configured to be measured by a mobile measurement device, and slots for securing the tie-in tool. The position indicators are located on the tie-in tool such that measurement of many of the position indicators forms a three-dimensional group measurement which is easily identifiable and replicable. As many group measurements of a part are taken using the mobile measurement device, the position indicators are included in the group measurements. In combining the group measurements of the part to form an aggregate measurement of the part, the shared individual measurements of the position indicators are used as a reference for overlaying the group measurements of the part.

### FIELD

This disclosure generally pertains to the field of metrology, and specifically to a tie-in tool for use with mobile measurement devices.

### BACKGROUND

The ability to measure with precision is the explicit aim of metrology, and an important factor in maintaining the integrity of machinery across many industries. In recent years, the capacity of mobile measurement systems to obtain accurate data has grown rapidly, as has the demand for such systems. In particular, Portable Coordinate Measuring Machines (PCMM)–referred to colloquially as an ARM—dominate the market for mobile metrology equipment.

Some known mobile measurement systems produce three-dimensional representations of real-world objects using a probe to record point measurements (e.g., individual measurements) at an object's surface. The point measurements are combined to form a Group measurement, a three-dimensional image of a portion of the object. Multiple Group measurements may be combined to form an image of the entire object (e.g., an aggregate image or aggregate measurement).

Some known mobile measurement systems produce three-dimensional representations of real-world objects using laser measurement technology to record thousands of data points per second (also called a point cloud).

However, at least some known mobile measurement systems face significant challenges due to inherent limitations thereof. For example, known mobile measurement systems can be susceptible to uncontrolled movement from external forces, such as unintentional bumps and vibrations, leading to inaccuracies which can denigrate the integrity of measurements. Often, these denigrations require that the entire measurement process must be redone.

Additionally, measuring some large parts in their entirety with known mobile measurement systems is difficult, if not impossible, from a single location. Current methods for measuring large parts require significant overlaps in measurement which are combined to cover the entire part. This is a time intensive process which is often unreliable and difficult to perform.

While it might appear logical to simply produce mobile measurement devices with longer arms, this is not feasible for reasons both economic and technical. Regarding the former, these devices are expensive. Larger versions would likely be prohibitively expensive. Regarding the latter, the load on the joints of an arm increase with length. As such, Engineers of mobile measurement devices cannot lengthen the devices' arm without reinforcing the joints. Such a change would compromise the compact, portable form factor of the device. Additionally, the positional relationship between the probe and the reference point is determined using the angles of each joint in conjunction with the length of the rods which form the arm; as the lengths of the rods increase, identical changes in angle result in larger margins of error with respect to measurement accuracy. Because of this, extremely long arms would require much finer angle measurements merely to maintain current margins of error.

### SUMMARY

In one aspect, a system is provided for use in measuring a part. The system includes a tie-in tool including a first plate and a second plate coupled to the first plate along a shared edge. The tie-in tool has a plurality of position indicators. Each of the position indicators is configured to be detected by a mobile measurement arm. The position indicators at least partially define a plurality of vertices of a three-dimensional shape. The system further includes a mobile measurement arm configured to perform a first group measurement of the tie-in tool by positioning the probe at each of the position indicators and recording a point measurement at each of the position indicators, perform a first group measurement of the part by positioning the probe at a first plurality of sites at a surface of a first portion of the part and recording a point measurement at each of the sites, perform a second group measurement of the tie-in tool by positioning the probe at each of the position indicators and recording point measurement at each of the position indicators, perform a second group measurement of the part by positioning the probe at a second plurality of sites at a surface of a second portion of the part and recording a point measurement at each of the second plurality of sites, and combine the first and second group measurements of the part to yield an aggregate measurement of the part. The combination is performed by aligning the point measurements at each of the position indicators from the first group measurement of the tie-in tool with the point measurements at each of the position indicators from the second group measurement of the tie-in tool.

In another aspect, a tie-in tool is provided for use in measuring a part. The tie-in tool includes a first plate having a first plurality of position indicators. Each of the first plurality of the position indicators is configured to be detected by a mobile measurement arm. The tie-in tool further includes a second plate coupled to the first plate along a shared edge. The second plate has a second plurality of position indicators. Each of the second plurality of position indicators is configured to be detected by the mobile measurement arm. The first and second pluralities of position indicators at least partially define a plurality of vertices of a three-dimensional shape such that measurement of the tie-in tool along the first and second plurality of position indicators using the mobile measurement arm yields the three-dimensional shape.

In yet another aspect, a method is provided for mobile precision measurement of a part comprising. The method includes performing a first measurement of a tie-in tool by positioning a probe of a mobile measurement arm at each of a plurality of position indicators on the tie-in tool and recording a point measurement at each of the plurality of position indicators, performing a first measurement of the part by positioning the probe at a first plurality of sites at a surface of a first portion of the part and recording a point measurement at each of the first plurality of sites, performing a second measurement of the tie-in tool by positioning the probe at each of the plurality of position indicators and recording a point measurement at each of the plurality of position indicators, performing a second measurement of the part by positioning the probe at a second plurality of sites at a surface of a second portion of the part and recording a point measurement at each of the second plurality of sites, and combining the first and second measurements of the part to yield an aggregate measurement of the part. The combination is performed by aligning the first and second measurements of the position indicators.

Other aspects will be in part apparent and in part pointed out hereinafter.

### BRIEF DESCRIPTION OF THE DRAWINGS

FIG. 1 is a perspective view of a tie-in tool according to an embodiment.

FIG. 2A and FIG. 2B are reverse elevations of the tie-in tool.

FIG. 3 is a perspective view of a measurement system including the tie-in tool, a mobile measurement device, and a part.

FIG. 4 is a flow chart showing a method of use for the tie-in tool according to an embodiment.

FIG. 5 is a flow chart showing a method of use for the tie-in tool according to an embodiment.

FIG. 6 is a flow chart showing a method of use for the tie-in tool according to an embodiment.

### DETAILED DESCRIPTION

For the purposes of this disclosure, the term "measure" may refer to recording either point measurements (e.g., individual measurements) or group measurements (e.g., many individual measurements). Group measurements includes laser scanned measurements.

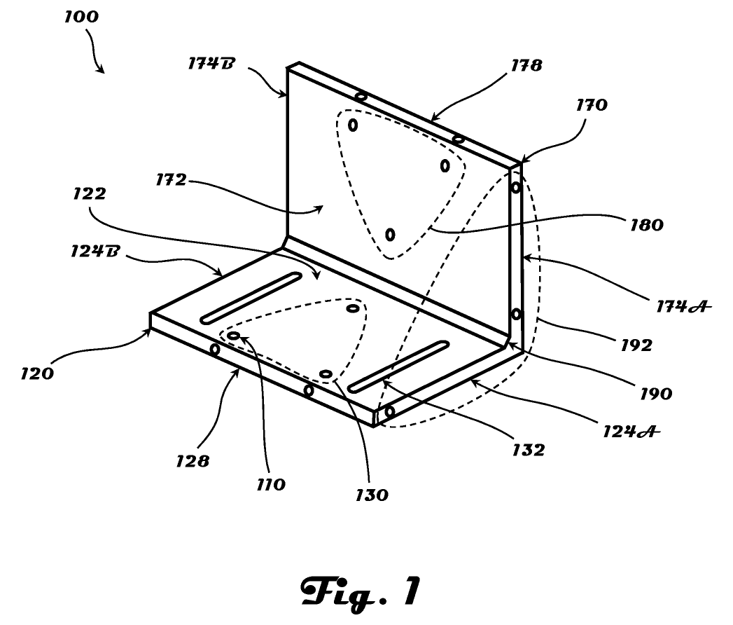

Referring to FIG. 1, an exemplary embodiment of a tie-in tool according to the present disclosure is shown, and generally indicated at reference number 100. The tie-in tool 100 broadly comprises a first plate 120 and a second plate 170 connected along a connection region 190, position indicators 110 configured to be measured (e.g., recorded) by a mobile measurement device, and slots 132 for securing the tie-in tool. The position indicators 110 are located on the tie-in tool 100 such that measurement of many of the position indicators forms a 3D group measurement which is easily identifiable and replicable. As many group measurements of a part are taken using the mobile measurement device, the position indicators 110 are included in the group measurements. In combining the group measurements of the part to form an aggregate measurement of the part, the shared individual measurements of the position indicators 110 are used as a reference for overlaying the group measurements of the part. As will be described in greater detail throughout the present disclosure, the tie-in tool 100 improves the accuracy with which two or more group measurements of a part are combined, and facilitates incremental measurements which prevent complete remeasuring in the event of a disturbance or mismeasurement in one or more group measurements.

The tie-in tool 100 may be formed through a number of manufacturing processes and/or from one or more materials. In some examples, the first plate 120 and second plate 170 are formed individually and joined along an edge to form the connection region 190. Alternatively, the first plate 120 and second plate 170 are formed from a single sheet which is bent, warped, or otherwise restructured to form the connection region 190 between the first plate and second plate. The first plate 120 and second plate 170 extend outwardly from the connection region 190 to form a substantially perpendicular angle. Alternatively, the first plate 120 and second plate 170 can extend from the connection region 190 at any other angle that enables the tie-in tool 100 to function as described herein.

The first plate 120 and second plate 170 include an upper face 122 and inner face 172, respectively. The terms upper face 122 and inner face 172 are used herein for convenience of description only and are not to be considered limiting of the orientation of the first plate 120, second plate 170, and/or any other feature described herein. The first plate 120 and second plate 170 each include a first short edge 124A/174A, a second short edge 124B/174B, and a long edge 128/178 extending therebetween. The specific proportions of the tie-in tool 100 described herein are provided for convenience of description only and are not considered limiting of the first short edge 124A/174A, second short edge 124B/174B, long edge 128/178, and/or any other feature described herein.

One of the first plate 120 or second plate 178 defines at least one slot 132 sized, shaped, and/or configured to receive a fastener through the upper face 122 or inner face 172. In the illustrated embodiment, the first plate 120 defines two slots 132. The fastener extends through the slot 132 (not shown), such that the tie-in tool 100 is detachably couplable to a stable surface. For example, the tie-in tool 100 may be coupled to a pallet. One or more heavy objects may be positioned on the pallet proximate to the tie-in tool 100 to facilitate stabilizing the tie-in tool, thereby mitigating the likelihood of movement in the event that a disturbance vibrates the site of the tie-in tool. In this manner, the tie-in in tool 100 may be effectively used in dynamic areas, such as construction zones, manufacturing facilities, transport hubs, etc.

Each of the first plate 120 and second plate 170 include a plurality of the position indicators 110 on the upper face 122 and inner face 172, respectively. The position indicators 110 are configured to provide stable, replicable measurement points for the probe of the mobile measurement device (ARM). In some examples, one or more of the position indicators 110 are indentations shaped and sized to receive a probe from the ARM. In this manner, an operator records a location of a position indicator 110 by positioning the probe therein. Additionally, or alternatively, one or more of the position indicators 110 may be shaped and sized to provide one or more detectable landmarks. In this manner, the locations of the position indicators are recorded by scanning the upper face 122 and inner face 172 for the position indicators 110.

The position indicators 110 are organized into groups defining a representative plane. For example, the upper face 122 and inner face 172 include a first plurality of position indicators 130 and a second plurality of position indicators 180, respectively, which define a first representative plane and a second representative plane. In some examples, one or more of the first short edge 124A/174A, the second short edge 124B/174B, or the long edge 128/178 include a third plurality of position indicators 192 which define a third representative plane at the first plate 120 and/or second plate 170.

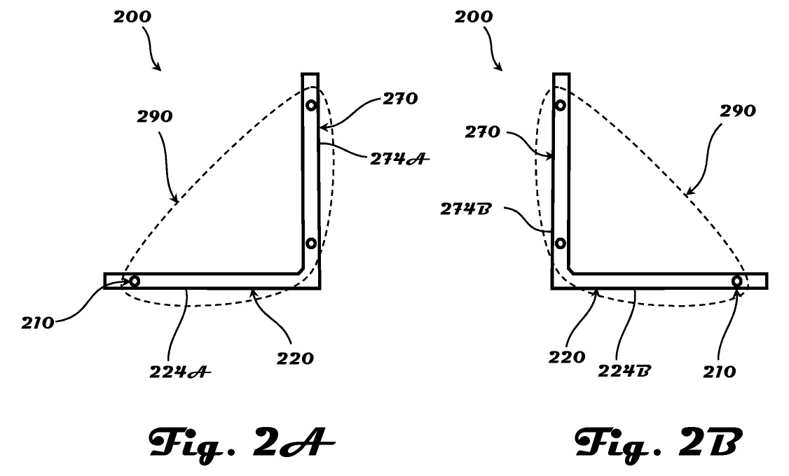

For example, referring to FIG. 2A, a third representative plane is defined by a plurality of position indicators 290 located on the first short edge 224A of the first plate 220 and the first short edge 274A of the second plate 270. Additionally, or alternatively, with reference to FIG. 2B, the third representative plane is defined by the plurality of position indicators 290 located on the second short edge 224B of the first plate 220 and the second short edge 274B of the second plate 270.

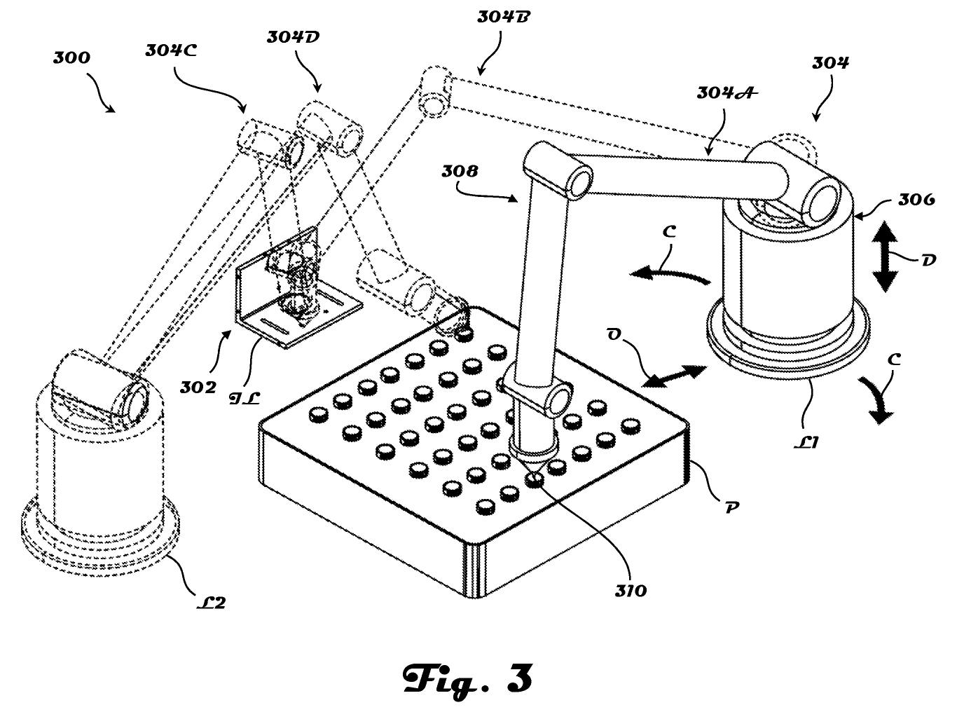

FIG. 3 shows a system 300 including a tie-in tool 302 (e.g., tie-in tool 100), a mobile measurement device 304, and a part P. The mobile measurement device 304 includes a base portion 306 and an arm portion 308 extending from the base portion to an end portion, which includes a probe 310 configured to measure the part P.

To facilitate positioning the probe 310 relative to the part P for measurement, the base portion 306 may be moved to a plurality of locations about the part, including at least a first location L1 and a second location L2. In some examples, the base portion 306 moves circumferentially around the part P (generally indicated at C), radially inward or outward relative to the part (generally indicated at O), and/or vertically upward or downward relative to the part (generally indicated at D). Alternatively, the base portion 306 may be moved in any direction and/or to any location that enables the system 300 to function as described herein. The arm portion 308 is rotatably coupled to the base portion 306, allowing the arm portion to be in a plurality of configurations, including at least configurations 304 A-D. For example, when the base portion 306 is positioned at the first location L1, the arm portion 308 may be moved to configuration 304A to position the probe 310 adjacent to the part P to measure the part and/or to configuration 304B to position the probe adjacent to the tie-in tool 302 to measure the tie-in tool. When the base portion is positioned at the second location L2, the arm portion 308 may be moved to configuration 304C to position the probe 310 adjacent to the tie-in tool 302 to measure the tie-in tool 302 and/or to configuration 304D to position the probe adjacent to the part P to measure the part.

During operation, the probe 310 is positioned at various points or locations on or near a surface of the part P and/or tie-in tool 302. At each location, a point measurement is taken which records the precise location of the probe 310 and, by extension, the surface of the part P, thereby allowing the surface of the part to be mapped. Similar to how a digital image is constructed using many individual pixels, a model of the part P is constructed using many individual point measurements. Many point measurements collectively create a three-dimensional image or model of the part P. Each measurement may be recorded manually using a trigger, button, or other hardware on the measurement device. In these modes, a single measurement is taken by actuating the hardware once, or many measurements taken consecutively by holding down the hardware. Additionally, or alternatively, measurements may be taken automatically. For example, in certain embodiments, the measurement device 304 is configured, upon actuation of a physical or digital switch, to continuously record the location of the probe 310 at fixed intervals (e.g., every 3 seconds). The tie-in tool 302 is compatible with mobile measurement devices regardless of the manner in which they record measurements.

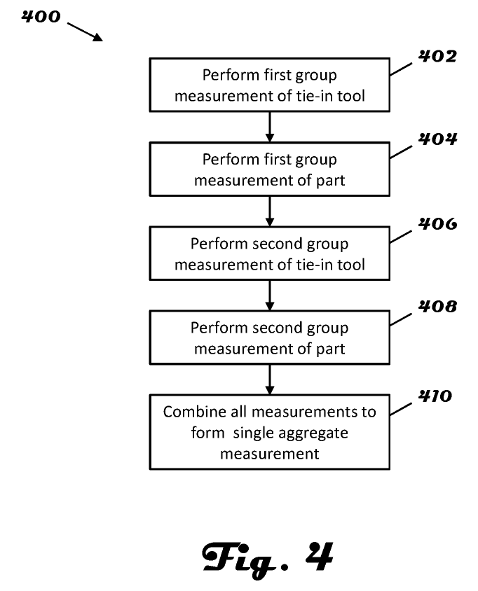

FIG. 4 shows an example method 400 for mobile precision measurement of a part (e.g., part P). In some examples, the method 400 is executed or implemented using a mobile measurement device (e.g., mobile measurement device 304) in conjunction with a tie-in tool (e.g., tie-in tool 100 or 302).

The method 400 includes performing, at operation 402, a first group measurement of the tie-in tool by positioning the probe at each of the plurality of position indicators and recording a point measurement thereat.

At operation 404, a first group measurement of the part is performed by positioning the probe at a first plurality of sites at a surface of a first portion of the part and recording a point measurement at each of the first plurality of sites.

At operation 406, a second group measurement of the tie-in tool is performed by positioning the probe at each of the plurality of position indicators and recording point measurement thereat.

At operation 408, a second group measurement of the part is performed by positioning the probe at a second plurality of sites at a surface of a second portion of the part and recording a point measurement at each of the second plurality of sites.

At operation 410, the first and second group measurements of the part are combined to yield an aggregate measurement of the part. The combination is performed by aligning the point measurements at each of the plurality of position indicators from the first group measurement of the tie-in tool with the point measurements at each of the plurality of position indicators from the second group measurement of the tie-in tool. The combination of group measurements may be performed manually or automatically (e.g., using software).

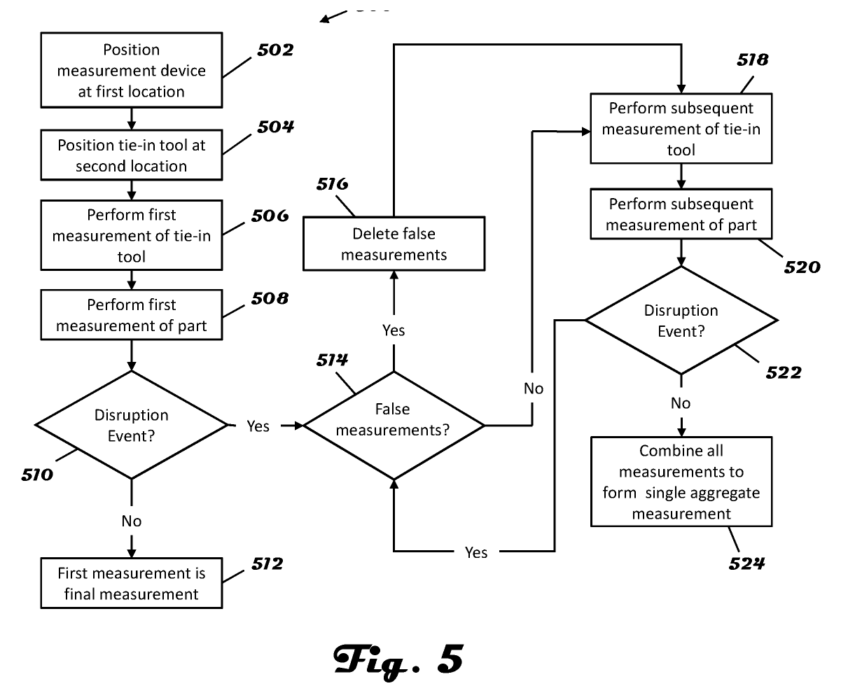

FIG. 5 shows a method 500 of using the tie-in tool (e.g., tie-in tool 100 or 302). Method 500 is an example method which provides a more detailed implementation of the operations described in method 400. The method 500 is configured to facilitate the quick, complete, and accurate aggregation of multiple group measurements of a part. Specifically, the method is directed toward the aggregation of group measurements taken before and after a disruption event (e.g., a vibration or bump).

At operation 502, a mobile measurement device is positioned at a first location in proximity to the part (i.e., within reach of the part).

At operation 504, the tie-in tool is positioned at a second location in proximity to at least the measurement device. The tie-in tool may be positioned near the part in order to minimize motion of the ARM as the ARM moves from the part to the tie-in tool and vice versa. The tie-in tool may optionally be secured to the ground or other stable structures via fasteners extending upwardly through at least one of the slots.

At operation 506, a first measurement of the tie-in tool is performed using the measurement arm. Measuring the tie-in tool includes locating the probe of the measurement arm at each of the position indicators on the tie-in tool and recording point measurements which correspond to the location of the probe. Measuring the tie-in tool may additionally/alternatively include scanning the tie-in tool using a contactless measurement component such as a laser scanner. Measuring more position indicators results in more accurate measurement aggregation in later operations. If the mobile measurement device uses a laser scanning apparatus as opposed to a probe, the operation of measuring the tie-in tool includes scanning (e.g., sweeping) the tie-in tool such that at least some of the plurality of position indicators are included in the scan.

At operation 508, a first group measurement of the part is performed using the mobile measurement arm. This is similar to measuring the tie-in tool, however there are no position indicators. Rather, a starting position, direction, and span of the first group measurement of the part must be determined using best judgement.

For all operations comprising a group measurement, including but not limited to operation 510, attention should be allocated to detection of measurement disruptions. Bumps, slides, vibrations, or other disruption events may move the mobile measurement device or the part, negatively impacting the precision and reliability of measurements. For example, if a group measurement were taken of a part during which a physical disturbance moves the mobile measurement device a centimeter from its initial location, the group measurement would not be an accurate representation of the part. Specifically, every point measurement in the group measurement recorded after the disruption event would be a centimeter removed from its true position. If no disruption event occurs, the measurement process of the part may be completed in a single operation. If, however, a disruption event does occur, the operator must take additional operations to continue measuring without either restarting the measurement process altogether or producing an inaccurate and therefore invalid record of the part.

At operation 510, evaluation of the presence and/or magnitude of a disruption event is performed. A disruption event includes any physical disturbance to the mobile measurement device or surrounding area (e.g., the part). Evaluation of the presence of a disruption event is not a discrete operation, but rather an ongoing process, and may be performed passively by an operator (e.g., noting a vibration beneath one's feet or hands, hearing a loud sound indicative of the operation of heavy machinery nearby, etc.). It may also be performed automatically by a motion sensor or related detection equipment. In some embodiments, the motion detector is an integrated component of the mobile measurement device. The magnitude of a disruption event may be determined using similar means or via an operator's best judgement.

At operation 512, the first group measurement is completed as a final, complete measurement of the part. Operation 512 is performed when no disruption event is detected, or when a disruption event is detected but determined to be of negligible magnitude.

Evaluation of false measurements is performed at operation 514. Operation 514 is performed when a disruption event is detected and determined to be of considerable magnitude (e.g., significant enough to have shifted the measurement device and/or the part). False measurements are measurements taken after a disruption event which, as a result of movement of the mobile measurement device or the part, are not an accurate representation of the surface of the part. A disruption event which results in false measurements may be a rapid, unanticipated movement or vibration of nearby structures or materials which does not afford an operator time to stop measuring. Examples include an irregular engagement or disengagement of an assembly in a factory, an offloading of heavy crates at a warehouse, or the use of heavy machinery at a construction site. A disruption event which would not likely result in false measurements is one which is easily anticipated, timed, or preceded by a forewarning to the operator. Examples include a timed engagement or disengagement of a manufacturing process (i.e., one which occurs over regular intervals), or the passing of a forklift whose presence is signaled with an alarm or siren. Evaluation of the presence of false measurements may be performed by reviewing the recorded point measurements in a mobile measurement software system.

At operation 516, false measurements are deleted. Operation 516 is performed when operation 514 results in a positive identification of false measurements. False measurements may be deleted manually via a mobile measurement software, or via a delete/undo function on the mobile measurement device.

At operation 518, a subsequent group measurement of the tie-in tool is performed. This is similar to operation 506, performing the first measurement of the tie-in tool.

At operation 520, a subsequent group measurement of the part is performed. With respect to the physical process of performing the measurement, this is no different from performing a first measurement of the part 508. However, because a disruption event has occurred, the first group measurement of the part is not a group measurement of the entire part. Similar to how the first group measurement of the part is preceded by a decision with respect to a starting measurement position, any and all subsequent group measurements should be preceded by consideration of where a preceding group measurement ended. If a disruption event is anticipated, and therefore no subsequent measurements recorded or deleted, the starting measurement position of a subsequent group measurement may be located at precisely the same location as the final point measurement of the preceding group measurement. For example, considering a part with portions A, B, C, D, and E, if an operator ceases measuring the part in anticipation of a disruption event after successfully completing group measurements of portions A, B, and C, they may choose to begin a subsequent group measurement at portion D and continue through portion E. If a disruption event is not anticipated, and false measurements therefore taken, a subsequent measurement may begin at a portion of a part which has already been measured. For example, continuing with the example of a part having portions A, B, C, D, and E, an unanticipated disruption event may occur during a group measurement of portion C. In this case, portion C may be remeasured completely before portions D and E. This significantly reduces the risk that any portion of the part is left unmeasured.

At operation 522, evaluation of the presence and/or magnitude of a disruption event is performed. This operation may be performed identically to operation 510. If a disruption event is identified and determined to be of considerable magnitude (i.e., significant enough to have shifted the measurement device and/or the part), operations 514-520 are repeated. These operations may be performed as many times as necessary to measure the part in its entirety.

At operation 524, the part has been measured in its entirety, and each measurement may be combined to form a single aggregate measurement of the part. This operation may be performed manually by an operator, automatically by a software system, or as a combination of these two. To combine group measurements such that an accurate model of the entire part is produced, each measurement must be combined on the basis of its positional relationship with respect to the tie-in tool, specifically the mutual point measurements of the position indicators. For example, consider a part with portions A and B, which is measured according to the aforementioned method wherein an anticipated disruption event occurs between group measurements A and B; In this instance, group measurement A may be associated with the first group measurement of the tie-in tool (i.e., they share a reference frame), and subsequent group measurement B associated with a subsequent (e.g., second) group measurement of the tie-in tool (i.e., they share a different reference frame). Because of the disruption event between group measurements A and B, their positional relationship is not representative of the surface of the part. Specifically, the discrepancy between the real shape and the measured shape of portion B is proportional to the movement of the measurement device resulting from the disruption event. To rectify this discrepancy, group measurement A and the first measurement of the tie-in tool may be combined (e.g., group AT), group measurement B and the second measurement of the tie-in tool may be combined (e.g., group BT), and final group measurements AT and BT may be combined on the basis of the measurements of the tie-in tool. Measurements of the tie-in tool may already be grouped with measurements of the part such that no combination is necessary. Because the positional relationship between the tie-in tool and the part is preserved despite the disruption event, the combination of group AT and group BT by the first and second measurements of the tie-in tool yields an aggregate measurement of the part which accurately reflects the surface of the part. Group measurements of the tie-in tool may then be removed.

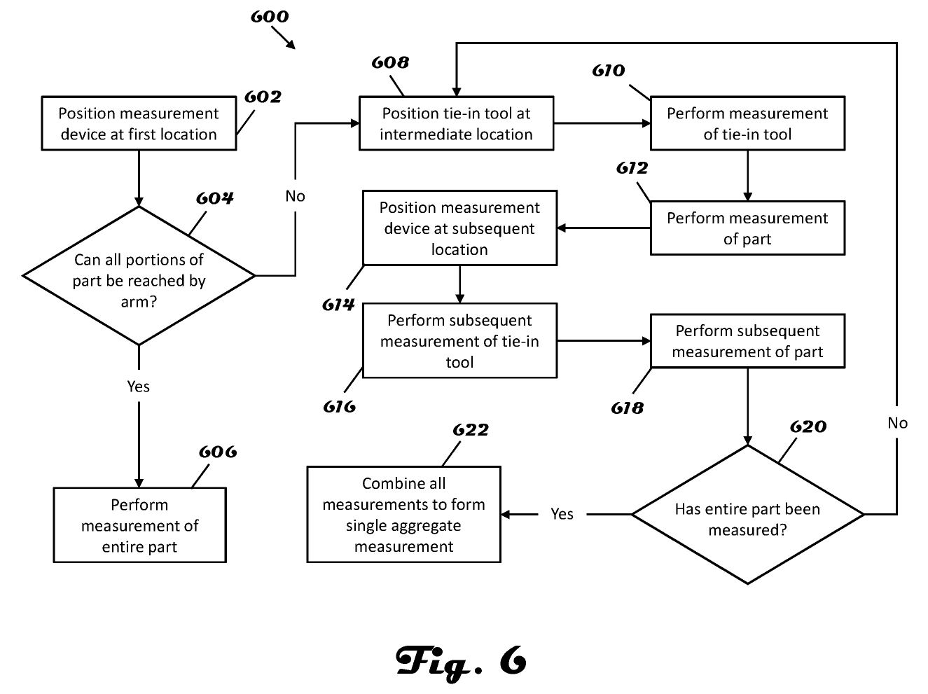

Referring now to FIG. 6, a method of use for the tie-in tool according to an embodiment is shown using a flow chart, and is generally depicted at reference 600. Method 600 is directed toward the use of the tie-in tool to facilitate the combination of multiple group measurements taken from different locations and is an expansion of the measurement process shown at method 400 of FIG. 4.

In order to measure parts that extend beyond the reach of a mobile measurement device's arm, the mobile measurement device must take multiple group measurements of the part from different locations. For reasons enumerated above, current methods of group measurement combination/aggregation are time intensive and unreliable; moreover, the mere enlargement of mobile measurement devices as a solution to these shortcomings is not currently physically or economically feasible.

At operation 602, the measurement device is positioned at a first location in proximity to the part (i.e., within reach of the part).

At operation 604, an assessment/evaluation of the mobile measurement device's reach is performed with respect to the part. If the part is sufficiently large, an operator may determine through a cursory inspection of the system that the mobile measurement device will need to be moved in-between measurements. The opposite may be true if the part is small enough that a cursory inspection of the system makes it obvious that the part may be measured from a single position. If the ability of the mobile measurement device to reach the entirety of the part is not obvious upon cursory visual inspection, a test measurement may be taken to realize the reach of the ARM.

Operation 606 is performed when operation 604 results in an affirmation of the mobile measurement device’s ability to span the entirety of the part. At operation 606, the part is measured in its entirety.

If operation 604 results in the realization that the mobile measurement device cannot span the entirety of the part, operation 608 may be performed. Operation 608 includes locating the tie-in tool at an intermediate location.

The term intermediate location describes a location between two or more possible measurement device locations which, in combination, allow the measurement device to reach both the intermediate location (i.e., the tie-in tool) and different portions of the part. If only two measurement device locations are needed to obtain group measurements spanning the entire part, there need be only one intermediate location which can be reached from both of the two possible measurement device locations. Referring briefly to FIG. 3, the tie-in tool 302 is at an intermediate location IL between measurement device locations L1 and L2. If more than two measurement device locations are needed to obtain group measurements spanning the entire part, multiple intermediate locations may be used to combine each group measurement. For example, if portions A, B, and C of a part are measured from locations A', B', and C', intermediate locations (i.e., tie-in tool locations) may be X' and Y', wherein X' is in proximity to the measurement device from locations both A' and B', and wherein Y' is in proximity to the measurement device from locations both B' and C'.

Referring back to FIG. 6, at operation 610, a first measurement of the tie-in tool is performed. This includes locating the probe of the measurement arm at least several of the plurality of position indicators on the tie-in tool and recording the position of the probe (point measurements). It is beneficial to the outcome of this method to measure many position indicators, as it produces more individual point measurements by which to aggregate multiple group measurements. If the measurement device uses a laser scanning apparatus as opposed to a probe, the operation of measuring the tie-in tool may include scanning the tie-in tool.

At operation 612, a first measurement of the part is performed. This is similar to operation 610 of measuring the tie-in tool, however there are no position indicators. Rather, a starting position, direction, and span of the first group measurement of the part must be determined using best judgement.

At operation 614, the measurement device is positioned at a subsequent location in proximity to both the part and the tie-in tool located at an intermediate location. The measurement device should be able to measure at least a portion of the part which is beyond the reach of the measurement device when located at the previous (e.g., first) location.

At operation 616, a subsequent measurement of the tie-in tool is performed from the same location at which the measurement device was located in operation 614.

At operation 618, a subsequent group measurement of the part is performed from the same location at which the measurement device was located in operation 614.

At operation 620, assessment of whether the part has been measured in its entirety (i.e., whether the sum of all group measurements yields an aggregate measurement of the entire part) is performed. If the part has not been measured in its entirety, operations 608-618 may be repeated. All subsequent placements of the tie-in tool at intermediate locations should facilitate the combination of subsequent group measurements of the part. For example, if a part must be partitioned into portions A, B, C, and D, corresponding to measurement device locations A', B', C', and D', the tie-in tool may be placed at intermediate locations in proximity to A'/B', B'/C', and C'/D'. If the part has been measured in its entirety, operation 622 is performed.

At operation 622 the part has been measured in its entirety and each group measurement of the part may be combined to form a single aggregate measurement. This operation may be performed manually by an operator, automatically by a software system, or by a combination of these two. To combine the measurements such that an accurate model of the entire part is produced, each measurement must be combined on the basis of its positional relationship with respect to the tie-in tool.

While the systems and methods above have been described and disclosed in certain terms and have disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A system for use in measuring a part, comprising:
a tie-in tool comprising a first plate and a second plate coupled to the first plate along a shared edge, the tie-in tool having a plurality of position indicators, wherein each of the plurality of the position indicators is configured to be detected by a mobile measurement arm, wherein the plurality of position indicators at least partially defines a plurality of vertices of a three-dimensional shape; and
a mobile measurement arm configured to:
perform a first group measurement of the tie-in tool by positioning the probe at each of the plurality of position indicators and recording a point measurement at each of the plurality of position indicators;
perform a first group measurement of the part by positioning the probe at a first plurality of sites at a surface of a first portion of the part and recording a point measurement at each of the first plurality of sites;
perform a second group measurement of the tie-in tool by positioning the probe at each of the plurality of position indicators and recording point measurement at each of the plurality of position indicators;
perform a second group measurement of the part by positioning the probe at a second plurality of sites at a surface of a second portion of the part and recording a point measurement at each of the second plurality of sites; and
combine the first and second group measurements of the part to yield an aggregate measurement of the part, wherein the combination is performed by aligning the point measurements at each of the plurality of position indicators from the first group measurement of the tie-in tool with the point measurements at each of the plurality of position indicators from the second group measurement of the tie-in tool.

2. The system of claim 1, wherein the first plate is substantially perpendicular to the second plate.

3. The system of claim 1, wherein one or more of the first plate or the second plate includes at least one slot defined therethrough and configured to receive a fastener.

4. The system of claim 1, wherein the tie-in tool is positionable in proximity to a measurement device positioned in proximity to the first portion of the part.

5. The system of claim 1, wherein the tie-in tool is securely fastened to a stable structure.

6. The system of claim 1, wherein the mobile measurement arm is configured to:
detect unintentional movement of the mobile measurement arm; and
delete at least one of the point measurements at the first plurality of sites at the surface of the first portion of the part.

7. A tie-in tool for use in measuring a part, comprising:
a first plate having a first plurality of position indicators, wherein each of the first plurality of the position indicators is configured to be detected by a mobile measurement arm;
a second plate coupled to the first plate along a shared edge, the second plate having a second plurality of position indicators, wherein each of the second plurality of position indicators is configured to be detected by the mobile measurement arm; and
wherein the first and second pluralities of position indicators at least partially define a plurality of vertices of a three-dimensional shape such that measurement of the tie-in tool along the first and second plurality of position indicators using the mobile measurement arm yields the three-dimensional shape.

8. The tie-in tool of claim 7, wherein the first plate is substantially perpendicular to the second plate.

9. The tie-in tool of claim 7, wherein:
the first plurality of position indicators is defined at an upper face of the first plate; and
the second plurality of position indicators is defined at an inner face of the second plate.

10. The tie-in tool of claim 7, wherein the first plate has a first short edge, a second short edge, and a long edge extending therebetween, wherein the first plate has a third plurality of position indicators at one or more of the first short edge, the second short edge, or the long edge.

11. The tie-in tool of claim 10, wherein the third plurality of position indicators at least partially define the plurality of vertices of the three-dimensional shape.

12. The tie-in tool of claim 7, wherein the second plate has a first short edge, a second short edge, and a long edge extending therebetween, wherein the second plate has a third plurality of position indicators at one or more of the first short edge, the second short edge, or the long edge.

13. The tie-in tool of claim 12, wherein the third plurality of position indicators at least partially define the plurality of vertices of the three-dimensional shape.

14. The tie-in tool of claim 7, wherein one or more of the first plate or the second plate includes at least one slot defined therethrough and configured to receive a fastener.

15. A method for mobile precision measurement of a part comprising;
performing a first measurement of a tie-in tool by positioning a probe of a mobile measurement arm at each of a plurality of position indicators on the tie-in tool and recording a point measurement at each of the plurality of position indicators;
performing a first measurement of the part by positioning the probe at a first plurality of sites at a surface of a first portion of the part and recording a point measurement at each of the first plurality of sites;
performing a second measurement of the tie-in tool by positioning the probe at each of the plurality of position indicators and recording a point measurement at each of the plurality of position indicators;
performing a second measurement of the part by positioning the probe at a second plurality of sites at a surface of a second portion of the part and recording a point measurement at each of the second plurality of sites; and
combining the first and second measurements of the part to yield an aggregate measurement of the part, wherein the combination is performed by aligning the first and second measurements of the position indicators.

16. The method of claim 15, further comprising:
positioning the measurement device at a first location in proximity to the first portion of the part; and
positioning a tie-in tool at a second location in proximity to the measurement device.

17. The method of claim 16, further comprising positioning the measurement device at the second location in proximity to a second portion of the part.

18. The method of claim 15, further comprising securely fastening the tie-in tool to a stable structure.

19. The method of claim 18, wherein:
the tie-in tool includes at least one slot defined therethrough and configured to receive a fastener; and
fastening the tie-in tool to a stable structure comprises detachably connecting the tie-in tool to the stable structure using a fastener received by the slot.

20. The method of claim 15, further comprising:
detecting unintentional movement of the mobile measurement arm; and
deleting at least a one of the recordings of a point measurement at the first plurality of sites at the surface of the first portion of the part.
